(19) United States
(12) Patent Application Publication
(10) Pub. No.: US 2005/0248720 A1
(43) Pub. Date: Nov. 10, 2005

(54) Eyeglass device with mechanical magnetic means for securing auxiliary lenses to eyeglass lenses

(75) Inventor: Simon Ping Sun Ng, Kowloon Bay (CN)

Correspondence Address: ALIX YALE & RISTAS LLP, 750 MAIN STREET, SUITE 1400, HARTFORD, CT, 06103, US

(73) Assignee: Auto-Winner Limited

(21) Appl. No.: 10/841,169

(22) Filed: May 7, 2004

(51) Int. Cl. G02C 9/00

(52) U.S. Cl. 351/47

(57) ABSTRACT

The invention involves an eyeglass mountable auxiliary lens device. The present device attaches at least partially to the eyeglasses through magnetic interaction and provides among other things a close fitting and aesthetically pleasing union between the eyeglasses and the auxiliary frames.

### BACKGROUND OF THE INVENTION

The present invention relates in general to eyeglasses and auxiliary lenses for attachment to eyeglasses.

Various means to attach auxiliary lenses to eyeglasses have been proposed over the years. However, these means typically utilize clips that are permanently attached to the auxiliary lenses. The clips then attach to the eyeglass frames. Other means to attach auxiliary lenses to eyeglasses include magnets or magnetic material attached to both the auxiliary and eyeglass frames and which engage each other to hold the auxiliary frames in place. These conventional arrangements for attaching to auxiliary lenses to eyeglasses have several drawbacks in that they are unattractive, require heavy frames, and are not closely associated with the eyeglasses and thus have large gaps between the auxiliary lenses and eyeglass frames that allow light refraction to interfere with vision. In addition, the shape of the eyeglass frames and the auxiliary frames are quite different, changing considerably the look of the eyeglasses when the two are attached in combination. Furthermore, the conventional arrangements are not functionally durable with the result being that not only is the viewable area of the glasses obstructed, but the auxiliary lenses often disassociate unexpectedly due to either a poor connection, or due to snagging of the auxiliary lenses on the wearer's apparel or surroundings.

### SUMMARY OF THE INVENTION

Briefly stated, the present invention in a preferred form is generally directed toward the attachment of auxiliary lenses to eyeglasses. In particular, the present invention includes a device by which auxiliary lenses are associated with mechanical and magnetic elements that attach to the eyeglasses.

The present invention includes a primary eyeglass frame with a primary bridge for supporting primary lenses therein. The primary eyeglass frame bridge may have magnetic and mechanical connecting elements.

A secondary eyeglass frame has a secondary bridge for supporting secondary lenses therein. The secondary eyeglass frame includes magnetic elements and mechanical connector elements mounted at said secondary bridge for engaging said primary bridge magnetic and mechanical elements so as to secure the secondary eyeglass frame to the primary eyeglass frame.

It is an object of the present invention to provide an eyeglass device to secure auxiliary lenses to an eyeglass frame that overcomes at least some of the above mentioned problems or provides the public with a useful alternative.

### BRIEF DESCRIPTION OF THE DRAWINGS

Other objects and advantages of the invention will be better understood to one of ordinary skill in the art from the following description made with reference to accompanying drawing in which:

FIGS. 1A through 1E shows various views of an eyeglass device having magnetic and mechanical elements in portions of the bridge of the primary and secondary frames in accordance with the present invention.

FIG. 2A through D shows top, front, side views and selected portions of the primary and secondary frames respectively of an eyeglass device in accordance with the present invention.

### DESCRIPTION OF THE PREFERRED EMBODIMENT

Briefly stated, the invention in a preferred form is an eyeglass accessory that is simple in structure and provides the advantageous association of secondary lenses with the primary lenses of eyeglasses. In particular and referring to the drawings in detail, there is shown an eyeglass device 10 having an eyeglass frame 12 for supporting primary lenses 14 thereon. The eyeglass frame 12 includes a bridge 16 that generally curves upwardly and outwardly from the plane of the frame 12. The area near the bridge 16 also may include attachment nose pad arms 80 which hold in place nose pads 82. The eyeglass frame 12 may include two side portions or members 18 extending outwardly and rearwardly therefrom for pivotally coupling arms 20 thereto.

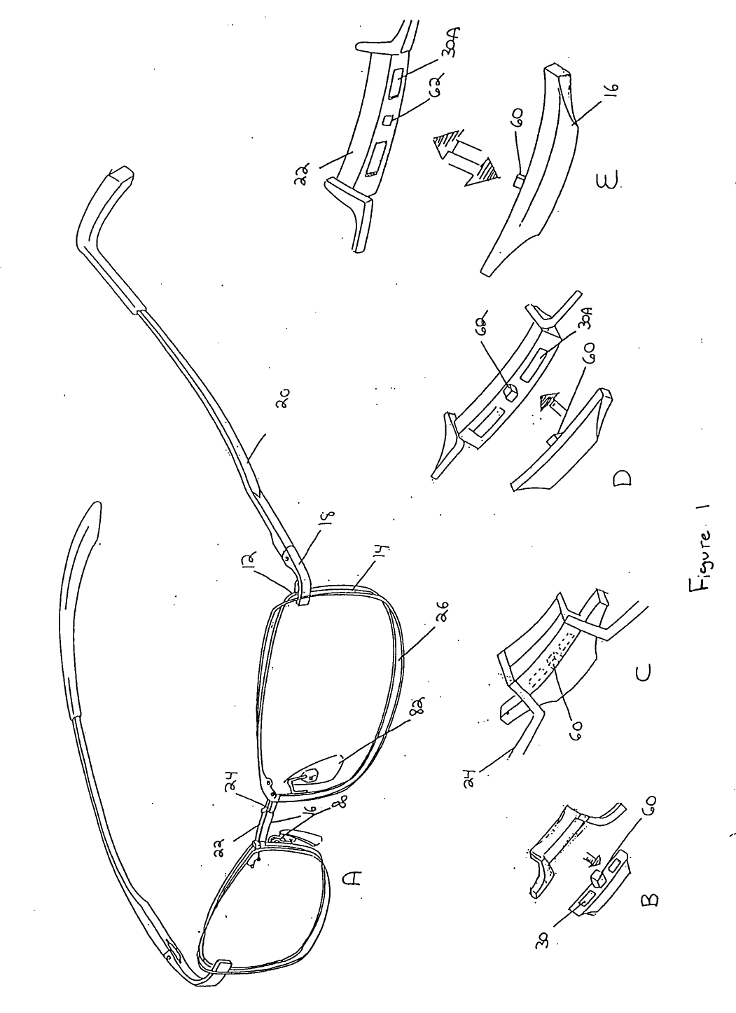

An auxiliary frame 24 can be generally shaped to correspond to the eyeglass frame 12. The auxiliary frame 24 includes a secondary bridge 22 that extends rearwardly from the line of the frame. The auxiliary frame 24 includes, in one embodiment of the invention, magnetic members 30A secured to a forward facing portion of the bridge 22. The magnetic members 30A engage with the eyeglass frame bridge 16, such that the auxiliary frame 24 is supported by the eyeglass frames, for example, as shown in FIG. 1. Generally, the magnetic members 30 may be fitted in cavities in the bridge 16, or they may be manufactured integrally with the bridge. The bridge 22 of the primary frame, for example, as in FIG. 1A may have magnets or be made of a magnetic material. The bridge 22 may support the auxiliary frames 24 by interaction magnets 30 and magnets 30A and may in addition have a mechanical pin 60 which penetrates into a socket 62 structure in the bridge 22. The mechanical pin 60 and associated socket 62 may have numerous complementary shapes. For instance, the pin 60 may be geometrically shaped in the form of, for example, a rectangle, oval, square, triangle, star, or may be fanciful in shape such as in the form of a letter or animal form. The associated socket 62 is of a shape that allows association with the pin 60.

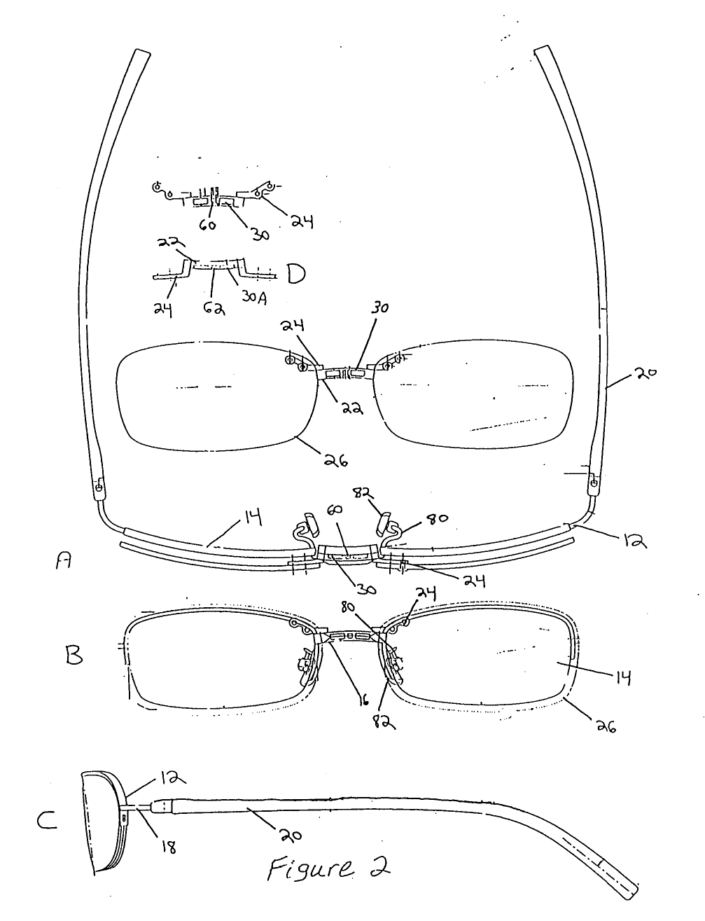

In one embodiment of the invention, as shown in, for example, FIGS. 1A-1D, the magnetic elements 30A of the auxiliary frame 24 are located on the bridge 22 of the auxiliary frame 24. The magnetic members 30A may be affixed, embedded, or other wise associated with bridge 22 that position the magnetic members to the rear of the auxiliary frame 24 facing forward. The magnetic members 30A may then magnetically interact with the eyeglass frame bridge 16 having magnetic properties or embedded magnets 30. The bridge 16 of the eyeglasses and the bridge 22 of the auxiliary frame may be configured with the auxiliary frame bridge 22 being positioned rearwardly as shown in, for example, FIG. 2. This configuration, among other things, ensures that the original design lines of the eyeglasses are not markedly changed when the auxiliary frame 24 is secured to the eyeglass frame 12.

The close integration of auxiliary frames 24 and the eyeglass frames 12 has many advantages, for instance, it reduces the overall weight of the device, reduces light entering from the side between the primary lens 14 and the auxiliary lens 26, and minimizes any change in the design look of the eyeglass frame.

In one embodiment of the invention, the pin 60 and socket 62 ensures that the primary frame is securely attached to the secondary frame to prevent shifting sideways or sliding between the two frames. The primary frame may be disengaged from the secondary frame by pressing the secondary frame rearward and then pushing upwards on the secondary frame.

While the preferred embodiments have been shown to describe the invention, various modifications and substitutions may be made thereto without departing from the spirit and scope of the invention. Accordingly, it is to be understood that the present invention has been described by way of illustration and not limitation.

1. An eyeglass apparatus comprising:
a primary eyeglass frame having a rear side, a pair of primary lens mounts, a primary bridge between the primary lens mounts, said primary bridge having magnetic material, and a primary bridge pin which extends in a substantially rearward direction;
a secondary eyeglass frame having a rear side, a pair of secondary lens mounts, a secondary bridge between the secondary lens mounts, said secondary bridge having a socket configured to receive said primary bridge pin; and
said secondary frame having magnetic material positioned to magnetically bond with said primary magnetic material on the primary frame bridge to retain said primary frame to said secondary frame.

2. The eyeglass apparatus of claim 1, wherein said secondary frame magnetic material is a first magnet and a second magnet, and said pin is located intermediate the first and second magnets.

3. The eyeglass apparatus of claim 2, wherein said primary frame magnetic material is a third magnet and a fourth magnet, and said socket is located intermediate the first and second magnets.

4. The eyeglass apparatus of claim 1, wherein said pin and said socket are substantially rectangular in shape.

5. An eyeglass apparatus comprising:
a primary lens frame having a primary bridge, said primary bridge having a rear facing magnetic fastening element and a first mechanical connector;
a secondary lens frame having a secondary bridge, said secondary bridge having a forward facing magnetic element for magnetic engagement with said rear facing magnetic fastening element on the primary bridge, said secondary bridge further having a second mechanical connector configured to engage said first mechanical connector.

6. The eyeglass apparatus of claim 5, wherein said rearward facing magnetic fastener element is a pair of magnets, and said forward facing magnetic fastener element is a pair of magnets.

7. The eyeglass apparatus of claim 6, wherein said first mechanical connector is located intermediate the rearward facing pair of magnets, and said second mechanical connector is located intermediate the forward facing pair of magnets.

8. The eyeglass apparatus of claim 5, wherein said first mechanical connector is a pin, and said second mechanical connector is a socket.

9. The eyeglass apparatus of claim 8, wherein the first mechanical connector and second mechanical connector are rectangular.
